(19) United States
(12) Patent Application Publication
(10) Pub. No.: US 2010/0111298 A1
(43) Pub. Date: May 6, 2010

(54) BLOCK CIPHER DECRYPTION APPARATUS AND METHOD

(75) Inventor: Scott A. Krig, Santa Clara, CA (US)

Correspondence Address: ADVANCED MICRO DEVICES, INC.;C/O VEDDER PRICE P.C., 222 N.LASALLE STREET, CHICAGO, IL, 60601, US

(73) Assignee: Advanced Micro Devices, Inc., Sunnyvale, CA (US)

(21) Appl. No.: 12/606,442

(22) Filed: Oct. 27, 2009

Related U.S. Application Data
(60) Provisional application No. 61/108,768, filed on Oct. 27, 2008.

(51) Int. Cl. H04L 9/18

(52) U.S. Cl. 380/37

(57) ABSTRACT

An apparatus and method obtains cipher block chaining mode (CBC) ciphertext blocks that were encrypted using a cipher block chaining encryption method, such a audio or video, and decrypts the CBC ciphertext blocks that were encrypted using the cipher block chaining encryption method using a multistage counter mode (CTR) decryptor to produce blocks of plaintext data from the CBC ciphertext blocks. In one example, cipher block chaining mode (CBC) information is translated (e.g., rearranged) to random counter mode (CTR) information so that a multistage counter mode (CTR) decryptor decrypts CBC ciphertext blocks into corresponding decrypted CBC plaintext blocks, in a parallel fashion, based on the translated CBC information. As such, apparatus with CTR hardware can be used to decrypt CBC or CFB ciphertext blocks.

### CROSS-REFERENCE TO RELATED APPLICATION

The present patent application claims priority from and the benefit of U.S. Provisional Patent Application No. 61/108,768, filed Oct. 27, 2008, and entitled BLOCK CIPHER CONSTRUCTION TRANSLATOR FOR CBC TO STEPPED CTR MODE, which is hereby incorporated herein by reference in its entirety.

### FIELD OF THE DISCLOSURE

The disclosure relates to apparatus and methods for decrypting information and more particularly to apparatus and methods for decrypting information using block ciphers.

### BACKGROUND OF THE INVENTION

Some digital rights management (DRM) systems in apparatus such as integrated circuits, audio players, portable phones, laptops and other devices require a cipher block chaining mode (CBC) construction to use the advanced encryption standard (AES) block cipher. As such devices are known that employ multistage CBC mode decryptors as shown in FIG. 1. However, if a device only provides random counter mode (CTR) construction to decrypt information instead, encoded information will not be able to be decoded by such devices. For example, devices are known that employ a multistage CTR mode decryptor as shown in FIG. 2, but do not have the multistage CBC mode decryptors as shown in FIG. 1.

The AES cipher can be used in a serial construction (Cipher Block Chaining mode, abbreviated CBC) or a parallel construction (Random Counter Mode, abbreviated CTR mode). These are referred to as AES-CBC or AES-CTR. Both AES-CBC and AES-CTR have a slightly different method of sending data through the AES cipher, and are not compatible.

For background, AES is a block cipher, which means that it operates on blocks of data. Typically, an application will take a large file or stream of data and break it into blocks and submit the data block-by-block to the AES cipher, which will either encrypt or decrypt the data as constructed.

AES is a family of block ciphers using a common fixed block size of 128 bits, and the family has variant block ciphers to support key sizes of 128, 192, 256 bits. Thus, AES, AES-128, AES-192, AES-256.

For decryption using CBC and CTR mode (and other modes as well), the AES cipher takes as input two items, a key and a block of data, and produces output by transforming the block of data using the key. The output of the cipher is then XOR'd with another value to yield the decrypted plaintext. Depending upon the construction, the ciphertext to decrypt is either input to the cipher or XOR'd with the cipher output as shown in FIGS. 1 and 2 below. As shown in FIG. 1, for the cipher block chaining mode decryption, CBC ciphertext blocks 102, 104, 106 are input into multiple stages of the cipher block decryptor 108. The first stage receives initialization vector data 110 as well as the key 112. The block cipher decryption stage utilizes, for example, ciphertext block 0 and key 122 to output deciphered information which is then XOR'd as shown by block 114 with the initialization vector data 110 to produce a corresponding block of plain text 126. A subsequent stage uses the CBC ciphertext block 0 as the input to the XOR operation 128 and also uses a subsequent CBC ciphertext block as input to the block cipher decryption operation along with key 112 to produce a corresponding block of plain text 130. A subsequent stage 132 uses the CBC ciphertext used in the previous stage to be XOR'd with the output from the deciphering of a CBC ciphertext block₂. Any suitable number of stages may be employed as known in the art.

As shown in FIG. 2, the multistage CTR decryptor 200 in its first stage 202 utilizes CTR ciphertext₀ which is XOR'd with the output of the CTR cipher block 204 to produce corresponding plain text 206. As shown input to the CTR block cipher includes key 208. Input to the block decryption block 204 is CTR nonce and counter data 210. The nonce information acts as, for example, randomizing information and the counter information is incremented for each stage as shown. As shown, the CTR ciphertext block 207 is XOR'd with the output from the block cipher decryption stage 204. In the second stage, a next CTR ciphertext block 230 is XOR'd with the output of the block cipher decryption block 232. The decryption block 232 deciphers the nonce and counter data 234 associated with a subsequent CTR ciphertext block using a key. The result is plaintext 236 that is a decrypted CTR ciphertext block 230. As shown, each stage includes an XOR block 238, 240 and 242. Any suitable number of stages may be employed as known.

The CBC ciphertext block 102 is encrypted using a cipher block chaining encryption method whereas the CTR ciphertext block 207 was encrypted using a CTR encryption method.

If a device only provides random counter mode (CTR) construction to decrypt information instead of CBC mode, encoded information that was encrypted using CBC encryption will not be able to be decoded by CTR decryptor devices. A need exists for an improved encryption and/or decryption apparatus and method.

### BRIEF DESCRIPTION OF THE DRAWINGS

The invention will be more readily understood in view of the following description when accompanied by the below figures and wherein like reference numerals represent like elements, wherein:

FIG. 1 is a block diagram illustrating one example of a prior art cipher block chaining mode decryptor;

FIG. 2 is a block diagram illustrating one example of a prior art random counter mode multi-stage decryptor;

FIG. 3 is a block diagram illustrating one example of a device employing a multi-stage counter mode decryptor to decrypt cipher block chain encrypted data in accordance with one example set forth in the disclosure;

FIG. 4 is a block diagram of one example of a multi-stage counter mode decryptor in accordance with one example set forth in the disclosure;

FIG. 5 is a flowchart illustrating one example of a method for decrypting encrypted information in accordance with one embodiment set forth in the disclosure; and

FIG. 6 is a flowchart illustrating a method of decrypting CBC encrypted data in accordance with one example set forth in the disclosure.

### DETAILED DESCRIPTION OF THE PREFERRED EMBODIMENTS

Briefly, an apparatus and method obtains cipher block chaining mode (CBC) ciphertext blocks that were encrypted using a cipher block chaining encryption method, such as audio or video, and decrypts the CBC ciphertext blocks that were encrypted using the cipher block chaining encryption method using a multistage counter mode (CTR) decryptor to produce blocks of plaintext data from the CBC ciphertext blocks. In one example, cipher block chaining mode (CBC) information is translated (e.g., rearranged) to random counter mode (CTR) information so that a multistage counter mode (CTR) decryptor decrypts CBC ciphertext blocks into corresponding decrypted CBC plaintext blocks in a parallel fashion based on the translated CBC information. As such, apparatus with CTR hardware can be used to decrypt CBC or CFB ciphertext blocks.

In one example, a software driver is used to translate CBC construction at the software level into CTR construction by re-arranging variables (i.e. information) and using the CTR construction (via the CTR multistage decryptor) in a controlled stepping manner, effectively emulating CBC decryption operation on CTR hardware (a multistage CTR mode decryptor). As known in the art, software drivers are code that are stored in computer readable memory, such as RAM, ROM or other suitable memory, that when executed cause one or more processors, such as a CPU or other processor, to allow higher level code to carry out operations with hardware such as graphics processors, other ASICs or other integrated circuits or devices.

In another example, an apparatus and method decrypts the CBC ciphertext blocks using a multistage counter mode (CTR) decryptor by controlling operation of stages of the multistage counter mode decryptor to generate a first block of plaintext from a first block of CBC ciphertext using CBC initialization vector data as a CTR ciphertext block in the multistage counter mode (CTR) decryptor. The method and apparatus generates, using another stage of the CTR decryptor, a second block of plaintext from a subsequent CBC ciphertext block using the subsequent CBC ciphertext block instead of subsequent CTR nonce and counter data and controlling operation of the CTR decryptor to use the first CBC ciphertext to XOR with output from a block cipher operation using the second CBC ciphertext block and associated decryption key.

Stated another way, a method and apparatus decrypts CBC ciphertext block₀ that was encrypted using a cipher block chaining encryption method, using a multistage counter mode decryptor by at least substituting CBC ciphertext block0 for CTR nonce and counter data0 and substituting CBC initialization vector data for CTR ciphertext0 in a first stage to generate a first decrypted CBC plaintext block from the CBC ciphertext blockₒ; and in at least a second stage of the multistage counter mode decryptor, substitutes CBC ciphertext blockN, where N is greater than 0, for nonce and counter dataN and substituting CBC ciphertext block(N−1) for CTR ciphertext blockN to generate a second decrypted CBC plaintext blockN from the CBC ciphertext blockN. Additional CBC ciphertext blocks are decrypted in parallel such as by decrypting another CBC ciphertext block in at least a third stage of the multistage counter mode decryptor in parallel with decrypting the CBC ciphertext block₀ and CBC ciphertext block_{N}.

Among other advantages, the apparatus and methods described above solve the problem of making the CBC and CTR constructions compatible, allowing a DRM system to use the AES-CBC method yet have it implemented using AES-CTR hardware by doing the translation in a software driver.

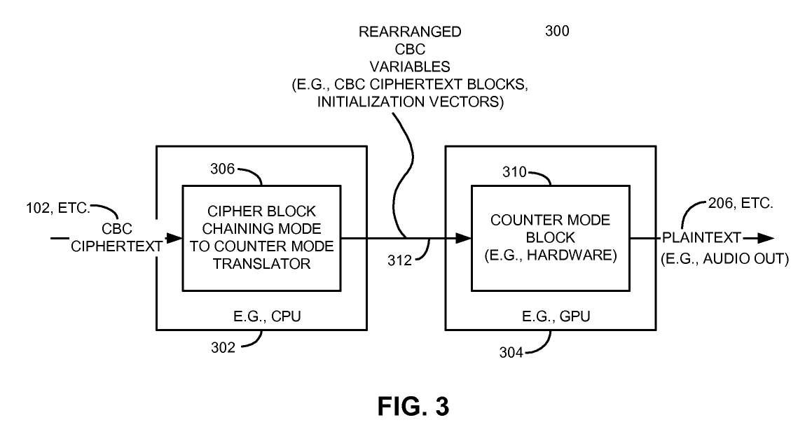

FIG. 3 illustrates one example of a device 300 that in this example includes a processor 302, such as a central processing unit and another processor 304 such as a graphics processing unit which may operate, for example, as a DRM system. In this example, the processor 302 operates as a cipher block chaining mode to counter mode translator 306 (i.e., AES Cipher Construction Cipher Translator) by, for example, executing driver code that is stored in memory that when executed causes the processor 302 to translate cipher block chaining mode information, such as CBC ciphertext and CBC initialization vector data, for example to CTR mode information such as by rearranging CBC variables to be placed in CTR multistage decryptor logic. The processor 302 via the cipher block chaining mode to counter mode translator 306 controls a multistage counter mode decryptor 310 to decrypt CBC cipher blocks into corresponding decrypted CBC plain text blocks, such as in a parallel fashion, based on the translated CBC information 312.

Block Cipher Decryption Construction Cipher Translator

While the example cited herein uses the AES cipher as an example, this technique applied equally well to any chosen block cipher including but not limited to RC5, DES, Blowfish, etc. Also, this invention applies to all AES family ciphers, and also to other block ciphers which use the CBC and CRT constructions. Also, this invention can be used to translate other constructions into CTR mode including but not limited to constructions such as cipher feedback mode (CFB).

In one example, the disclosed apparatus and methods provide a method of translating between AES CBC mode and AES CTR mode. Currently, these two cipher constructions are incompatible. As set forth herein, the method and apparatus may be thought of as involving creating a synthesized cipher function and equation, substituting variable, and starting the AES cipher in CTR mode for each block, treating the first block as a special case, and calling the CTR mode construction each time as if it were the first time called in the construction with a block count of 1.

It has been found that in order to use a CTR construction in place of CBC construction, the elements of the construction of the decryption equation simply need to be re-arranged and the feeding of blocks into the construction needs to be managed in the manner described herein.

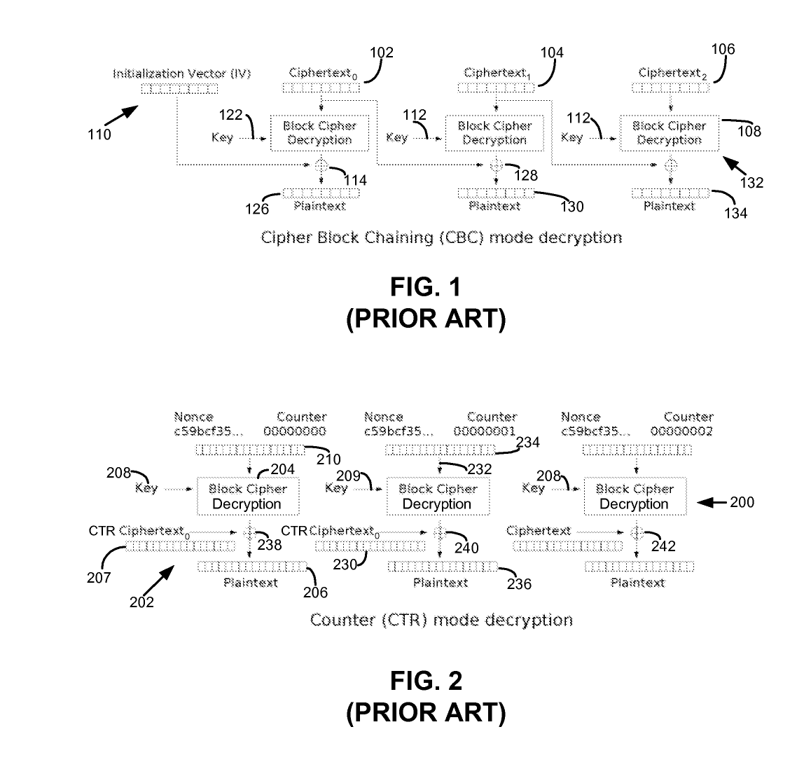

As shown in FIGS. 1 and 2 and FIG. 4, the following equations describe the CBC and CTR constructions.

CBC decryption construction equation:

Plaintext_block[n]=E(K,ciphertext_block[n]) XOR VALUE

where:
VALUE=Random IV when n=0, and VALUE=ciphertext block[n−1] for n>0
K=cipher key (128, 192, or 256 bits for AES family) E(K,n) is the AES block cipher function

CTR decryption construction equation:

Plaintext_block[n]=E(K,counter+nonce) XOR ciphertext_block[n]

where:
K=cipher key (128, 192, or 256 bits for AES family)
Counter+nonce is a block of appropriate size for the cipher as shown in FIG. 1. E(K,n) is the AES block cipher function

These equations will now be synthesized together and written in a more abbreviated canonical form for purposes of substitution:

P[n]=E(K,C)XORV

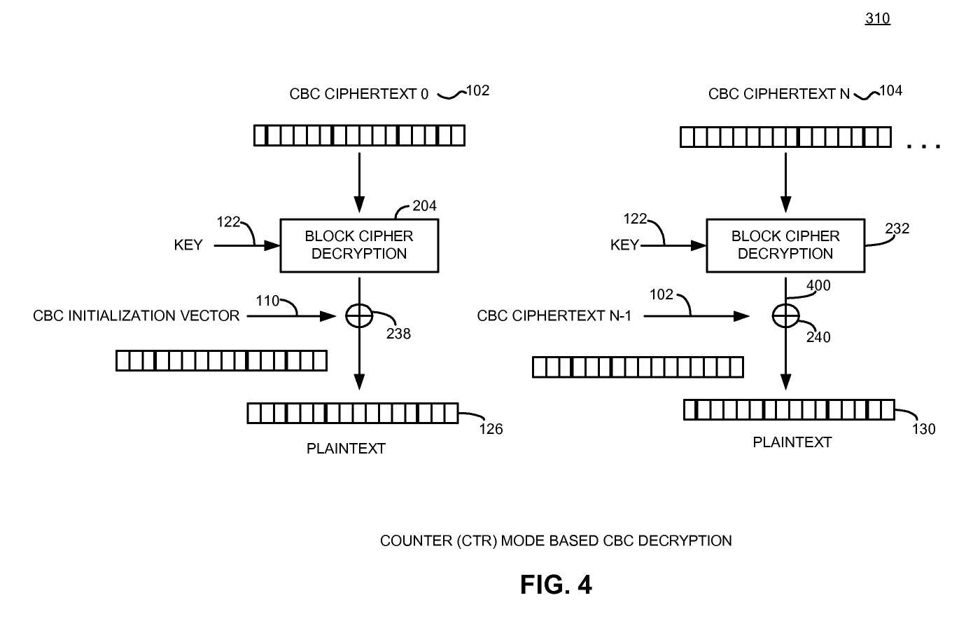

It has been found that to implement the translation between CBC mode and CTR mode using a multistage CTR mode decryptor, substituting the equivalent variables from the CBC construction into the appropriate places in the CTR construction is performed. Referring to the CBC and CTR diagrams above (FIGS. 1 and 2) and to FIG. 4, the variable substitution is carried out to use the multistage CTR decryptor 310 to decrypt CBC ciphertext blocks as follows where the first block is treated as special-case and subsequent blocks can be treated within a loop:

FIRST BLOCK: In the CTR mode translation construction for the first block:
D=CBC Ciphertext[0]->(Nonce|Counter)
Block Cipher Executes E(K, D)
R=CBC Initialization Vector IV->CTR Ciphertext[0]
Plaintext[0]=R XOR E(K,D)

SUBSEQUENT BLOCKS: In the CTR mode translation for subsequent blocks:
D=CBC Ciphertext[n]->(Nonce|Counter)
Block Cipher Executes E(K, D)
R=Ciphertext[n−1]
Plaintext[n]=R XOR E(K,D)

Note that the Plaintext[n] equation is always the same and the E(K,D) function is always the same. Only the location of variables in the equations are re-ordered to make the CBC construction fit into the CTR construction.

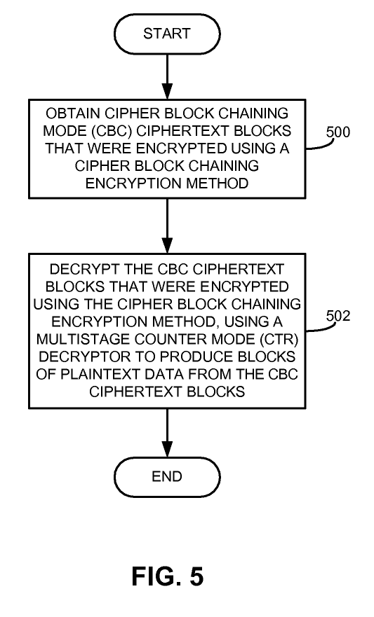

Referring to FIG. 5, and as set forth above, a method of decryption includes obtaining cipher block chaining mode (CBC) ciphertext blocks, such as by the multistage CTR decryptor 310, receiving rearranged CBC variables from processor 302, or in any other suitable manner as shown in block 500. The method also includes as shown in block 502, decrypting by, for example, the multistage CTR decryptor, the CBC ciphertext blocks 102, 104 and 106, that were encrypted using the cipher block chaining encryption method, using the multistage CTR decryptor 310 to produce blocks of plain text data 126, 130, 134 from the CBC ciphertext blocks 102, 104 and 106. The cipher block chaining mode to counter translator 306 (e.g., an executing driver) controls operation of stages of the multistage CTR decryptor 310 by providing the rearranged CBC information in a substituted manner that allows the CTR decryptor 310 to carry out a deciphering operation, to generate a block of plaintext from a corresponding block of CBC ciphertext and as shown above and in FIG. 4, using CBC initialization vector data 110 as CTR ciphertext block 207 to be XOR'd with the output of the block cipher 204. Stated another way, the CBC initialization vector data is substituted for the CTR ciphertext data 207 in the first stage of the CTR decryptor 310. In the same stage, CBC ciphertext block 102 is substituted for nonce and counter data 210 to serve as input to the block cipher operation as shown by block 204 in FIG. 4.

In a second stage, a second block of plain text 130 is generated from a subsequent CBC ciphertext block 104. Accordingly, the subsequent CBC ciphertext block 104 is used instead of subsequent CTR nonce and counter data 234 (see FIG. 2). The data substituted to control operation of the CTR decryptor 310 to also use the CBC ciphertext 102 (see second stage shown in FIG. 4) to XOR with output 400 from block cipher operation shown by block 232, using subsequent CBC ciphertext block 104 and an associated decryption key 122 to produce the plain text 130. This is illustrated above as set forth in paragraph 0036. The rearranged or substituted CBC information may be provided to the multistage CTR decryptor in a parallel fashion to allow parallel CBC decryption using a multistage CTR decryptor.

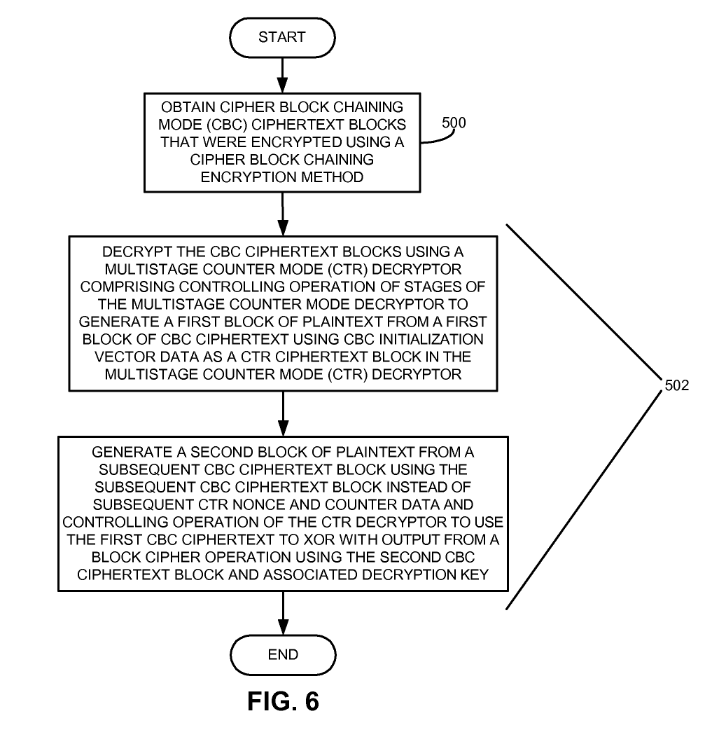

Stated another way, as set forth above and again as shown in FIG. 6, a method of decrypting ciphertext in a device includes decrypting CBC ciphertext block₀ 102 that was encrypted using a cipher block chaining encryption method, using a multistage CTR decryptor 310 by substituting or rearranging CBC ciphertext block 102 in place of normally received CTR nonce and counter data 210. The method also includes substituting CBC initialization vector data 110 for CTR ciphertext 0 207 in a first stage of the multistage decryptor 310 to generate a first decrypted CBC plain text block 206 from the CBC ciphertext block 0 102. In a subsequent stage, the method includes substituting CBC ciphertext block N 104 in place of normally provided nonce and counter data 234 and also substituting CBC ciphertext block 102 for CTR ciphertext block 230 to generate a decrypted CBC plain text block 130 from the CBC ciphertext block 104. For a subsequent stage, for example, the method includes decrypting another CBC ciphertext block 106 using another stage of the multistage CTR decryptor 310 and parallel with decrypting the CBC ciphertext block 102 and CBC ciphertext block 104 by providing the information to the CTR decryptor in a parallel fashion.

In another example, cipher feedback mode (CFB) ciphertext that was encrypted using a cipher feedback mode encryption technique may be decrypted using a multistage CTR decryptor in a similar manner as set forth above. The rearrangement of values is shown below:

FIRST BLOCK: In the CTR mode translation construction for the first block:

R=CFB Ciphertext[0]->CTR Ciphertext[0]

Block Cipher Executes E(K, D)

D=CFB Initialization Vector IV->(Nonce|Counter)

Plaintext[0]=R XOR E(K,D)

SUBSEQUENT BLOCKS: In the CTR mode translation for subsequent blocks:

R=CFB Ciphertext[n]->CTR Ciphertext[n]

Block Cipher Executes E(K, D)

D=Ciphertext[n−1]->(Nonce|Counter)

Plaintext[n]=R XOR E(K,D)

Among other advantages, the apparatus and methods described herein utilize a CTR construction such as a multistage CTR decryptor to decrypt CBC ciphertext blocks. Accordingly, digital rights management systems and other devices may provide CBC ciphertext decryption without employing dedicated CBC hardware. Other advantages will be recognized by those of ordinary skill in the art.

The above detailed description of the invention and the examples described therein have been presented for the purposes of illustration and description only and not by limitation. It is therefore contemplated that the present invention cover any and all modifications, variations or equivalents that fall within the spirit and scope of the basic underlying principles disclosed above and claimed herein.

What is claimed is:

1. A method of decrypting ciphertext comprising:
obtaining cipher block chaining mode (CBC) ciphertext blocks that were encrypted using a cipher block chaining encryption method; and
decrypting the CBC ciphertext blocks that were encrypted using the cipher block chaining encryption method, using a multistage counter mode (CTR) decryptor to produce blocks of plaintext data from the CBC ciphertext blocks.

2. The method of claim 1 wherein decrypting the CBC ciphertext blocks using a multistage counter mode (CTR) decryptor comprises controlling operation of stages of the multistage counter mode decryptor to generate a first block of plaintext from a first block of CBC ciphertext using CBC initialization vector data as a CTR ciphertext block in the multistage counter mode (CTR) decryptor.

3. The method of claim 2 further comprising generating a second block of plaintext from a subsequent CBC ciphertext block using the subsequent CBC ciphertext block instead of subsequent CTR nonce and counter data and controlling operation of the CTR decryptor to use the first CBC ciphertext to XOR with output from a block cipher operation using the second CBC ciphertext block and associated decryption key.

4. A method of decrypting ciphertext in an apparatus comprising:
decrypting CBC ciphertext block₀ that was encrypted using a cipher block chaining encryption method, using a multistage counter mode decryptor by at least substituting CBC ciphertext block0 for CTR nonce and counter data0 and substituting CBC initialization vector data for CTR ciphertext0 in a first stage to generate a first decrypted CBC plaintext block from the CBC ciphertext block₀; and
in at least a second stage of the multistage counter mode decryptor, substituting CBC ciphertext blockN, where N is greater than 0, for nonce and counter dataN and substituting CBC ciphertext block(N−1) for CTR ciphertext blockN to generate a second decrypted CBC plaintext blockN from the CBC ciphertext blockN.

5. The method of claim 4 comprising:
decrypting, another CBC ciphertext block in at least a third stage of the multistage counter mode decryptor in parallel with decrypting the CBC ciphertext block₀ and CBC ciphertext block_{N}.

6. An apparatus comprising:
at least one processor operative to translate cipher block chaining mode (CBC) information to random counter mode (CTR) information; and
a multistage counter mode (CTR) decryptor, operatively coupled to the processor, and operative to decrypt CBC ciphertext blocks into corresponding decrypted CBC plaintext blocks based on the translated CBC information.

7. The apparatus of claim 6 wherein the at least one processor controls operation of a stage of the multistage counter mode decryptor to generate a first block of plaintext from a first block of CBC ciphertext using CBC initialization vector data as a CTR ciphertext block in the multistage counter mode (CTR) decryptor.

8. The apparatus of claim 7 wherein the at least one processor controls operation of a stage of the multistage counter mode decryptor to generate a second block of plaintext from a subsequent CBC ciphertext block using the subsequent CBC ciphertext block instead of subsequent CTR nonce and counter data and controlling operation of the CTR decryptor to use the first CBC ciphertext to XOR with output from a block cipher operation using the second CBC ciphertext block and associated decryption key.

9. The apparatus of claim 6 wherein the processor executes driver code stored in memory, that when executed causes the processor to translate cipher block chaining mode (CBC) information to random counter mode (CTR) information.

10. An apparatus comprising:
a digital rights system operative to:
decrypt CBC ciphertext block0 that was encrypted using a cipher block chaining encryption method, using a multistage counter mode decryptor by at least substituting CBC ciphertext block0 for CTR nonce and counter data0 and substituting CBC initialization vector data for CTR ciphertext0 in a first stage to generate a first decrypted CBC plaintext block from the CBC ciphertext block₀; and
in at least a second stage of the multistage counter mode decryptor, substitute CBC ciphertext blockN, where N is greater than 0, for nonce and counter dataN and substituting CBC ciphertext block(N−1) for CTR ciphertext blockN to generate a second decrypted CBC plaintext blockN from the CBC ciphertext blockN.

11. The apparatus of claim 10 wherein the digital rights management system is operative to decrypt, another CBC ciphertext block in at least a third stage of the multistage counter mode decryptor in parallel with decrypting the CBC ciphertext block₀ and CBC ciphertext block_{N}.

12. A computer readable storage medium comprising executable instructions that when executed by one or more processors causes the one or more processors to:
to translate cipher block chaining mode (CBC) information to random counter mode (CTR) information; and
control a multistage counter mode (CTR) decryptor to decrypt CBC ciphertext blocks into corresponding decrypted CBC plaintext blocks based on the translated CBC information.

13. A method of decrypting ciphertext comprising:
obtaining cipher feedback mode (CFB) ciphertext blocks that were encrypted using a cipher feedback encryption method; and
decrypting the CFB ciphertext blocks that were encrypted using the cipher block chaining encryption method, using a multistage counter mode (CTR) decryptor to produce blocks of plaintext data from the CFB ciphertext blocks.
